(19) United States
(12) Patent Application Publication
(10) Pub. No.: US 2001/0049741 A1
(43) Pub. Date: Dec. 6, 2001

(54) METHOD AND SYSTEM FOR BALANCING LOAD DISTRIBUTION ON A WIDE AREA NETWORK

(76) Inventors: BRYAN D. SKENE, SEATTLE, WA (US); SCOTT P. TENNICAN, SEATTLE, WA (US); THOMAS E. KEE, MUKILTEO, WA (US)

Correspondence Address: MERCHANT & GOULD PC, P.O. BOX 2903, MINNEAPOLIS, MN, 55402-0903, US

(21) Appl. No.: 09/459,815

(22) Filed: Dec. 13, 1999

Related U.S. Application Data
(60) Provisional application No. 60/140,101, filed on Jun. 18, 1999.

(51) Int. Cl. G06F 15/16

(52) U.S. Cl. 709/232

(57) ABSTRACT

A system and method for balancing the load on virtual servers managed by server array controllers at separate data centers that are geographically distributed on a wide area network such as the Internet. The virtual servers provide access to resources associated with a domain name request by a client program. When a Primary Domain Name System (DNS) determined the requested domain name is delegated to a EDNS, the EDNS employs metric information and statistics to resolve an ip address for a virtual server that is selected by the EDNS to optimally balance the load and provide access to resources associated with the domain name. The EDNS may employ a static or a dynamic load balancing method to select the virtual server most suited to balance the load across all of the virtual servers. The EDNS may include a Primary DNS or a Secondary DNS. The EDNS employs an agent program located at geographically distributed data centers to collect metric information related to a host machine, server array controller, virtual servers and the path for providing resources associated with the domain name to a client making the request. The EDNS collects the metric information from the agent program out of band of the domain name resolution process. The server array controller may include the agent program and the agent program may be provided as a stand alone machine that is coupled to the server array controller or a host machine.

### RELATED APPLICATIONS

This utility patent application is a continuation of a previously filed U.S. Provisional Patent Application, U.S. Ser. No. 60/140,101 filed on Jun. 18, 1999, the benefit of the filing date of which is hereby claimed under 35 U.S.C. 119(e).

### FIELD OF THE INVENTION

This application relates generally to distributing the load demand between servers on a network, and, more specifically, to balancing the load demand between geographically distributed redundant servers on a wide area network.

### BACKGROUND OF THE INVENTION

In the past, a wide area network (WAN) of geographically distributed servers for data centers and Internet sites was more susceptible to reliability, inconsistent performance, and scalability issues than a network of local servers. Also, balancing the load demand between geographically distributed servers for web-based applications and content such as email and streamed multimedia data has proven to be difficult for several reasons. One reason is that when a geographically distributed server fails, there has not been a facility for automatically redirecting client requests to another server that could also fulfill the client's request. Another reason is that adding and/or removing servers from a geographically distributed network has proven to be difficult. Also, previous methods for balancing the load between geographically distributed servers have not employed intelligent algorithms for automatically connecting a client to the server that can optimally fulfill the request.

Therefore, it is desirable to provide a system for automatically determining active and inactive servers in a geographically distributed network so that client requests can be automatically distributed to active servers capable of fulfilling the requests. Preferably, the system could seamlessly integrate with an industry standard Domain Name System (DNS) such as the Berkeley Internet Domain Name System (BIND) and support an unlimited number of geographically distributed servers. Also, the system could enable redundant servers to be removed and/or added to the distributed network in a transparent fashion. Additionally, this system should provide a method for intelligently analyzing statistics and several different metrics so that the load can be optimally balanced between redundant servers in a geographically distributed network

### SUMMARY OF THE INVENTION

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates an overview of the system architecture for implementing the present invention with a separate Primary DNS and a separate EDNS system;

FIG. 2 shows an overview of the system architecture for implementing the present invention with a Primary DNS that includes a EDNS system;

FIG. 3A illustrates an overview of the system architecture for implementing the present invention with a Primary DNS that includes a Primary EDNS system at multiple locations;

FIG. 3B shows an overview of the system architecture for implementing the present invention with a Primary DNS that includes a Primary EDNS system and a Secondary DNS that includes a Secondary EDNS at separate locations;

FIG. 3C illustrates an overview of the system architecture for implementing the present invention with a Primary DNS that includes a Primary EDNS system and a Secondary DNS that includes a Primary EDNS at separate locations;

FIG. 3D shows an overview of the system architecture for implementing the present invention with a Primary DNS that includes a Primary EDNS system and a Primary DNS that includes a Secondary EDNS at separate locations;

FIG. 3E shows an overview of the system architecture for implementing the present invention with stand alone EDNSA programs and a EDNSA program included with a Secondary EDNS at separate locations;

FIG. 4 illustrates an overview of the main logic flow of the present invention;

FIGS. 5A and 5B show the logic flow for a separate Primary DNS and a separate EDNS system;

FIGS. 6A and 6B illustrate the logic flow for a Primary DNS that includes a EDNS system;

FIG. 7 shows the logic flow for collecting load balancing metrics out of band;

FIG. 8 illustrates the logic flow for selecting one of several predetermined load balancing methods;

FIG. 9 shows the logic flow for employing the selected load balancing method to determine the optimal virtual server for the client;

FIGS. 10A and 10B illustrate the logic flow for implementing a selected dynamic load balancing method; and

FIG. 11 shows the logic flow for using a selected static load balancing methods;

FIG. 12 illustrates the overall system architecture for a EDNSA program that has spawned child programs to collect the load balancing metrics out of band for a Primary EDNS server;

FIG. 13 shows an exemplary topology statement for use with a topology load balancing method; and

FIG. 14 shows an exemplary topology score statement for use with a Quality of Service load balancing method.

### DETAILED DESCRIPTION

The present invention provides a method for optimizing the accessibility and availability of data on a scaleable, fault tolerant wide area network (WAN). In accordance with this invention, any one of several different types of load balancing methods can be employed to analyze metric information and optimally balance client requests (load demand) between redundant geographically distributed virtual servers. These load balancing methods include RTT (round trip time), RR (round robin), least connections, packet completion rate, quality of service, server array controller packet rate, topology, global availability, hops, static ratio and dynamic ratio. The metric information can be used by the present invention to determine an optimal load balancing method and generate statistics. Also, since the metric information is collected outside the domain name resolution process, the invention can respond y quickly to a client request. Prior to describing the invention in greater detail, a list of particular terms and their definitions is provided below.

Definition of Terms

Virtual server array Controller—A virtual server array controller (SAC) manages and balances network traffic on an intranet. One embodiment of a SAC is the “BIG/ip” server array controller produced by F5 Networks, Incorporated of Seattle, Wash. The SAC intelligently distributes site connections across arrays of servers, transparent firewalls, transparent cache servers, routers as well as other router-like devices. The SAC is designed to manage connections to multiple Internet or intranet sites, and it supports a wide variety of Internet protocols and services such as TCP/IP and HTTP. Also, the SAC monitors several aspects of the node servers that deliver content associated with a domain name.

Virtual Server—A specific combination of a virtual IP address and a virtual port number on a SAC or a Host machine. Access to the virtual server is managed by the controller or Host machine.

Node Server—A specific combination of a node address and a node port number on an intranet behind a SAC. The SAC manages the node servers and maps each virtual server to one or more node servers.

Host machine—Can be a single network server or a SAC for managing multiple servers.

Domain Name System (DNS)—A distributed database that maps host names to Internet protocol (ip) addresses. A DNS server is used to resolve host names associated with ip addresses.

Primary Extended Domain Name system (EDNS) Server—A Primary EDNS server collects metric information for virtual servers that are managed by a SAC. One embodiment of the Primary EDNS server is a 3DNS server produced by F5 Networks, Incorporated of Seattle, Wash. On a wide area network, all EDNS servers are peers and each Primary EDNS server monitors and collect data (metric information) for each virtual server that is managed by a SAC. Based on configuration information, the Primary EDNS server will determine the virtual servers that are associated with a particular name or service. Typically, a EDNS server is designated as a Primary or Secondary system using a global sub-statement, i.e., primary_ip. The Primary EDNS server employs the collected metric information to determine the virtual address for a virtual server that will balance the load caused by a request for access to resources associated with a domain name (ip address).

Secondary Extended Domain Name System (EDNS) Server—A Secondary EDNS server can copy metric information from a Primary EDNS server at defined intervals that are specified with a global sub-statement, e.g., sync_db_interval. An important aspect of the Secondary EDNS server is that it can copy metric information from a Primary EDNS server and does not have to independently collect this information. The Secondary EDNS server employs the copied metric information to determine the virtual address for a virtual server that will balance the load caused by a request for access to resources associated with a domain name (ip address). However, the Secondary EDNS server can also collect the metric information separately from the Primary ENDS server. Also, one embodiment of the Secondary EDNS server is produced by F5 Labs, Incorporated of Seattle, Wash.

Primary DNS (zone) Server—A Primary DNS server is an authoritative source for zone information related to the name suffix, e.g., “.com” and “.net”. All DNS servers can resolve names, but zone files are only configured and kept by the Primary DNS server.

Secondary DNS Server—A Primary DNS server instructs each Secondary DNS server when it should get its database from the Primary DNS server on a zone-by-zone basis. The Secondary DNS may copy zone files from the Primary DNS server when it starts up, when a timer expires in a Start of Authority (SOA) record, or when a dynamic update has occurred to the zone file. The SOA record is a resource record used to define a zone. Zone files are the database of DNS and these resource records, in a hierarchical structure, make up the DNS.

Local DNS—A DNS server that makes name resolution requests on behalf of a client. Also, from the EDNS systems' perspective, the local DNS is the source of a name resolution request.

End-point—The item, e.g., a virtual server, that is controlled by the SAC or Host machine that the Primary EDNS server is monitoring. For a SAC, the end-point is any virtual server that is managed by the SAC. When the Primary EDNS server collects information from a Host machine, the end-point is the ip address of the virtual server.

iQuery Protocol—A UDP-based protocol that is used to communicate and exchange information between SACs and EDNS servers. For example, a Primary EDNS server will send iQuery questions to a SAC via port 245 or 4353. The iQuery protocol is officially registered with the IANA for port 4353, and iQuery can run on either that port or on the original port 245. A SAC reply is returned through a local ephemeral port which is randomly assigned by the Primary EDNS server or alternatively either port 245 or 4353 as a single port for return iQuery traffic; and iQuery can be set to include translated IP addresses in iQuery packets (useful for configurations where iQuery communication between a SAC and a EDNS system passes through a firewall). Additionally, the iQuery communication may be encrypted.

Extended Domain Name System Agent (EDNSA)—A client (agent) program that can run on a SAC or a EDNS server and answer queries from every EDNS server on a network. The EDNSA client may also be a stand alone system that communicates with a SAC, EDNS and a Host machine. One embodiment of the EDNSA is a BIG/3D client program produced by F5 Networks, Incorporated of Seattle, Wash.

Wide ip—A Wide ip statement is used to map a domain name to a set of virtual servers managed by SACs or other Host machines. Also, the Wide ip statement may be used to map a domain name to a load balancing mode that is performed by a EDNS server. The Wide ip statement includes a Wide ip key which is the same ip address as specified by the domain name's “A” resource record in the zone file. Alternatively, the Wide ip key could be employed to bind the information from the DNS servers to the EDNS system and indicates to the DNS servers that the EDNS system (within the named process) should attempt to handle requests to the domain name. In this way, the EDNS system resolves a request by making a decision based upon its metric information database and returns an answer to a client domain name request. When the preferred, alternate and fall back load balancing methods in a Wide ip system fails, the EDNS system instructs the DNS to reissue its original answer. When this event occurs, the Wide ip key is relied upon as the fall back address.

Time to Live (TTL)—Each TTL variable is used to control how long information is saved in a particular cache that a server uses to make decisions. There are two important TTL values that affect decisions made by a EDNS system, i.e., zone minimum TTL variables and object limit TTL variables. A zone minimum TTL variable contains a field for each resource record in a zone file. Each EDNS object has an associated TTL object limit variable associated with metric information. When a TTL object limit variable expires, the EDNS system will stop using a dynamic load balancing method and revert to a static method.

Internet Service Provider (ISP)—A client accesses resources on a WAN through a local ISP. The client may connect to the local ISP through a telephone modem, cable modem and/or satellite connection. The Local ISP usually provides a local DNS service that communicates with other servers on the WAN for resolving a domain name request into an ip address.

Hops—An intermediate connection in a string of connections linking two network devices. On the Internet, for example, most data packets need to go through several intermediate systems (routers, Host machines, switches, or layer 3 network device) before they reach their final destination. A hop is defined as a stop at an intermediate system (IS) for evaluation and then forwarded on to the next IS known to the current IS. Each time the packet is forwarded, a hop occurs. The more hops, the longer it takes for data to go from source to destination The number of hops a packet takes to get to another Internet host can be measured by using a trace route utility. A contiguous network may have fewer intermediate hops and may enable a packet to be transferred faster than a non-contiguous network.

Theoretically, the fewer hops it takes to get a packet onto the Internet backbone, the faster access will be for a client. A raw hops variable would include all of the ip addresses that passed on the packet from the source to its destination. A hops variable could also indicate how much of the time the packet was passed on by a continuous network from the source to its destination. A packet transfer tends to be faster and more reliable on continuous networks.

System Architecture

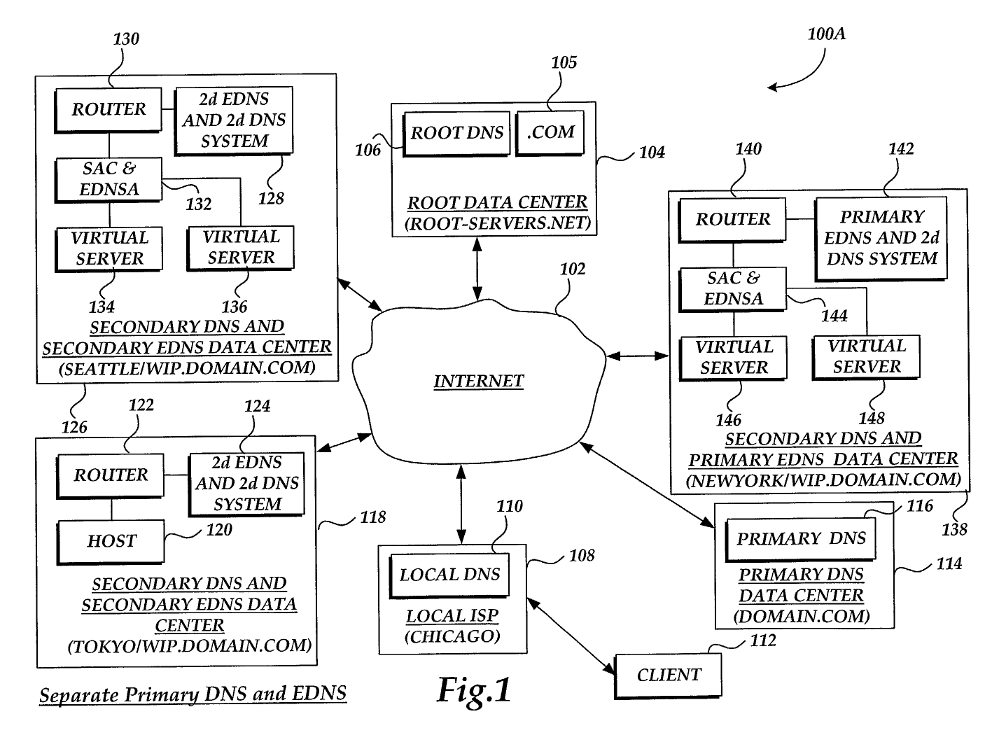

In FIG. 1, an overview 100A illustrates an embodiment of a WAN architecture that includes the present invention added to a network that includes a Primary DNS server for resolving ip address associated with a domain name request. At least one separate Primary EDNS server may be used as the authoritative source for a sub-domain name. Also, separate Secondary EDNS servers may be provided at geographically distributed locations where they receive copies of metric information that is collected by the Primary EDNS server.

The transaction process for this embodiment of the present invention begins with a request from a client 112 for resources associated with a domain name, e.g., www.domain.com. The client communicates the domain name request to a local ISP 108 that provides a local DNS server 110 for resolving the domain name request into an ip address associated with the requested domain name. In this example, the local ISP 108 is a separate computer system that may provide other types of services to the client 112 such as email and web page hosting. The local ISP 108 will pass a client's domain name request to the local DNS server 110 to determine if the requested information resides in its cache. If so, the local DNS server 110 will provide the resolved ip address associated with the requested domain name to the client. If the resolved ip address does not reside in the cache for the local DNS server, the local DNS will communicate through the Internet 102 with a data center 104 that supports a root DNS server 106, i.e., a DNS server associated with the domain name “root-servers.net.” The root DNS server 106 analyzes the client's domain name request (“www.domain.com”) and passes this request to a “.com” DNS server 105 that assists in resolving ip addresses associated with domain names that have the “.com” suffix. The “.com” DNS server returns to the local DNS server 110 an ip address for another data center 114 that supports a Primary DNS server 116 that is an authoritative source for zone information related to “domain.com.”

The Primary DNS server 116 refers the local DNS server 110 to an authoritative sub-domain server for resolving the actual ip address associated with the client's domain name request. In this example, the Primary DNS server 116 refers the local DNS to the Wide ip address of a Primary EDNS server 142 supported by a data center 138 located in New York, New York (newyork/wip.domain.com), because this EDNS server is designated as the WAN's authoritative source for this sub-domain name. At the data center 138, a router 140 is coupled between the Internet 102 and the Primary EDNS server 142 and a SAC 144. The SAC manages communication with a pair of redundant node servers 146 and 148. Also, for the requested domain name, the Primary DNS server 116 will create a public alias (CNAME) name for a name in the sub-domain that is delegated to the Primary EDNS server 142.

Next, the local DNS 110 will query the Primary EDNS server 142 at the Wide ip address to resolve an ip address associated with the client's domain name request. The Primary EDNS server 142 will determine a Wide ip address for a selected endpoint that is best suited to respond to the domain name request and returns this determined Wide ip address to the client 112. For the purposes of this example, the Primary EDNS server 142 has selected an end-point at another data center 126 located in Seattle, Wash. (seattle/wip.domain.com) that includes a Secondary EDNS server 128 in communication with a SAC 132 and a router 130 which provide access to other servers and services connected to the Internet 102. The SAC 132 includes an EDNSA program that provides metric information to the Primary EDNS server when it receives an iQuery protocol request.

When the time to live (TTL) value for a determined Wide ip address is set to a relatively short period of time, the Local DNS will come back to the Primary EDNS each time to resolve a domain name and the load on the EDNS system is high because it must determine the optimal virtual server for each domain name request. Conversely, when the time to live (TTL) value for a determined Wide ip address is a relatively long period of time, the Local DNS does not have to come back to the Primary EDNS each time to resolve a domain name and the load on the EDNS system will be low.

Lastly, the client 112 connects to the selected end-point at the determined Wide ip address, which is also the virtual address assigned to one of the redundant node servers 134 and 136 that are managed by the SAC 132. Once the connection is made to the selected end-point, the client may access resources that are associated with the domain name.

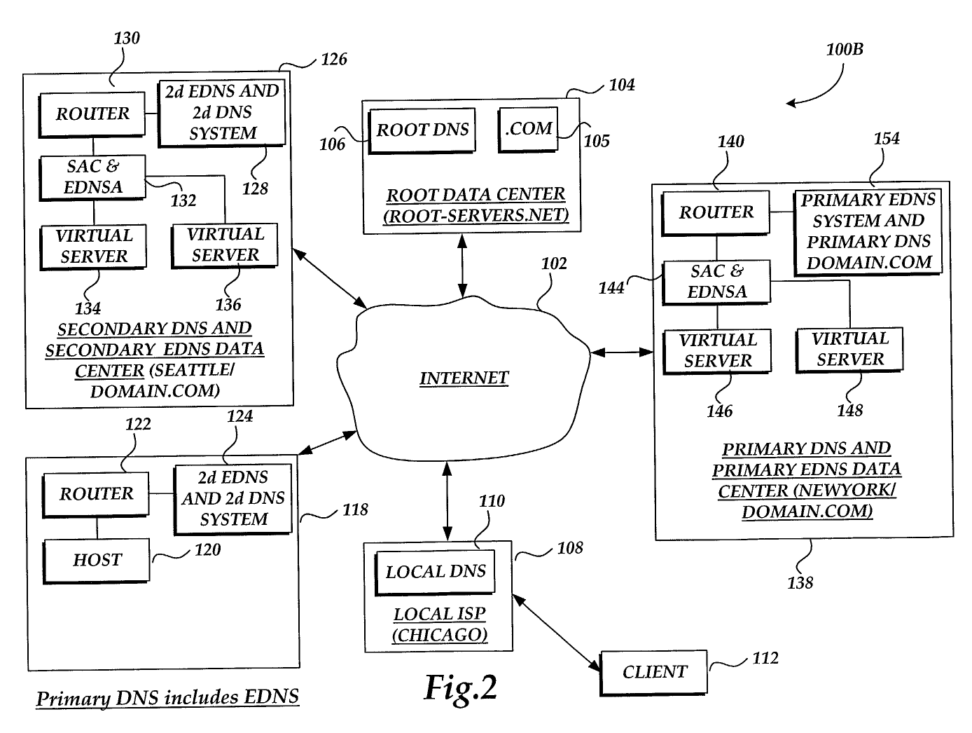

FIG. 2 illustrates an overview 100B of another embodiment of a WAN architecture that is substantially similar to the network architecture shown in FIG. 1. However, in this case, the Primary DNS server also includes a local Primary EDNS server that is an authoritative source for the sub-domain name (“domain.com”) associated with the client's domain name query.

The transaction process is similar to the steps discussed above for FIG. 1 until the local DNS server 110 connects to the data center 138 that includes Primary DNS and Primary EDNS servers 154 in the same system. In this configuration, the Primary EDNS server will handle the resolution of the client's domain name request by sending an ip address to the local DNS server 110 for the optimal virtual server to provide the client with access to resources associated with the domain name. The local DNS server 110 passes the resolved ip address to the client 112 which connects to the selected end-point at the ip address of a geographically distributed data center 126, e.g., seattle/domain.com. The client 112 will use the resolved ip address to connect through the ISP 108 to the selected end-point (virtual server) at the data center 126 in Seattle, Wash.

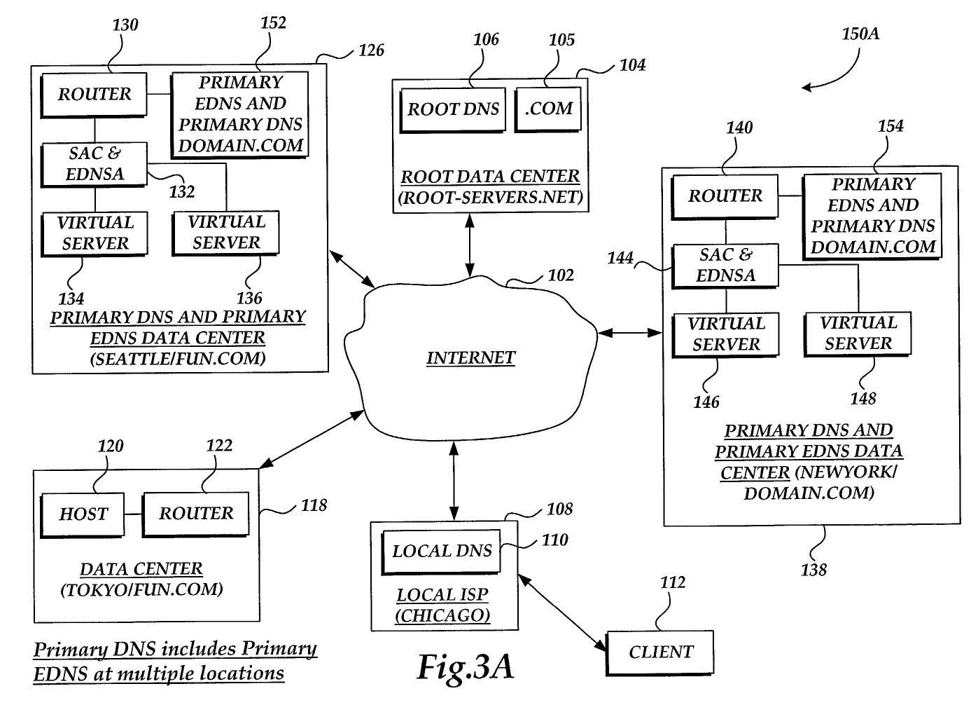

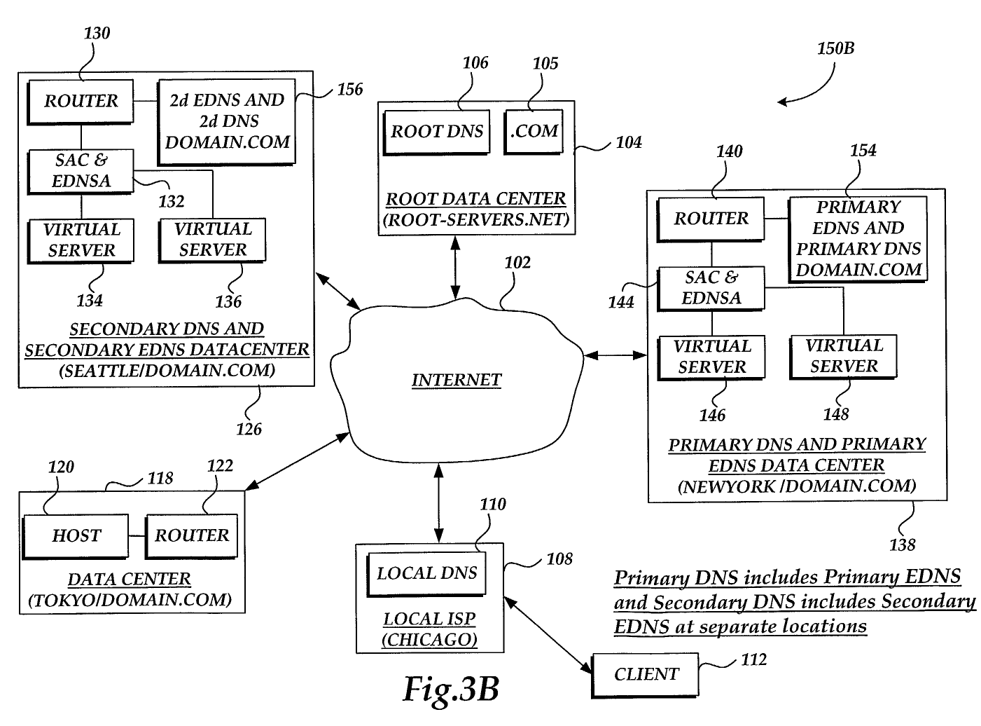

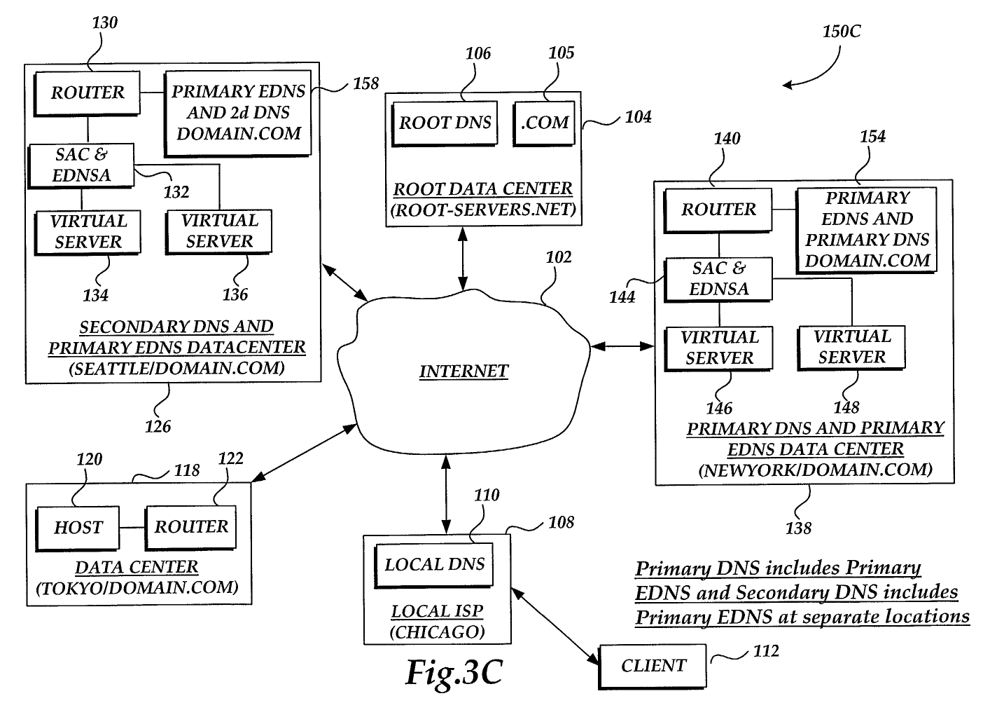

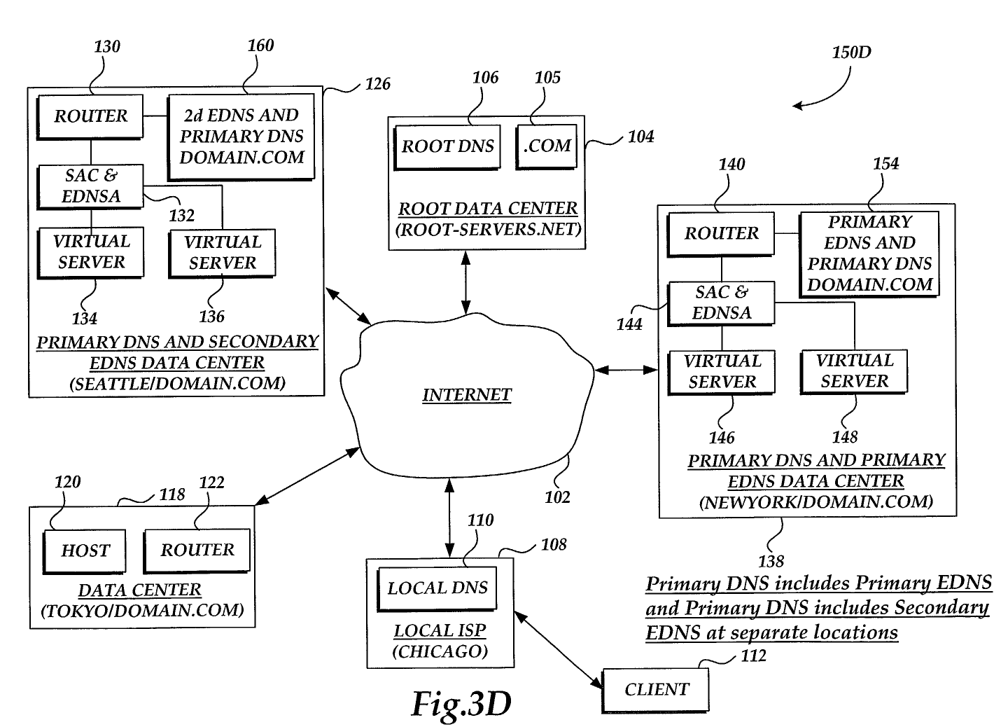

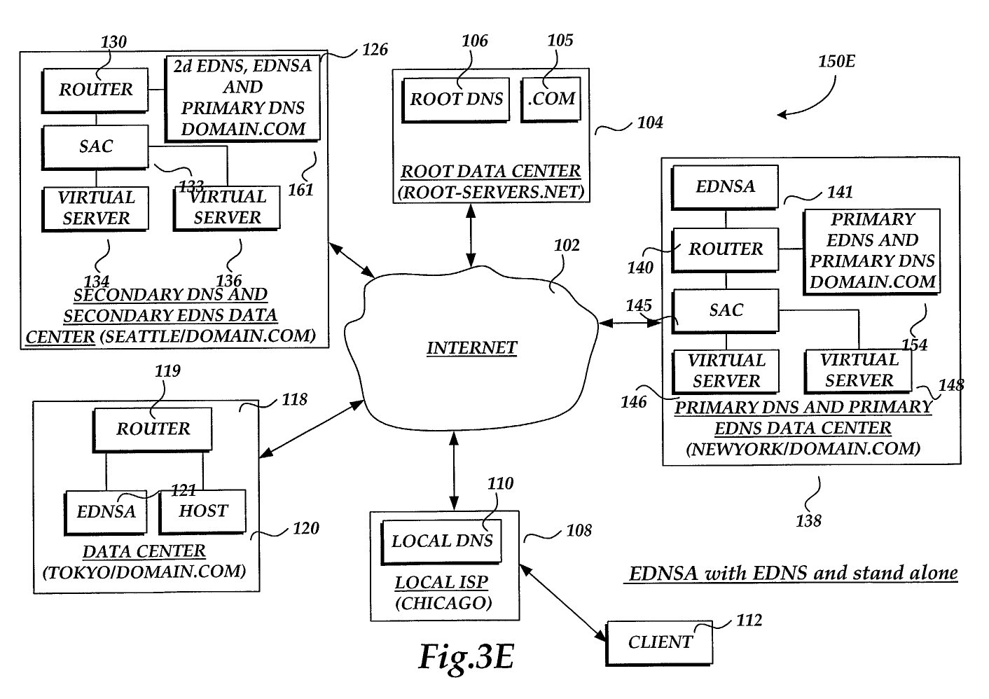

In FIG. 3A, an overview 150B is shown of another embodiment of a WAN architecture that is somewhat similar to the network architecture shown in FIG. 2 except that it includes multiple Primary DNS and Primary EDNS servers in separate geographically remote data centers. The transaction process is similar to the steps discussed above for FIG. 2 except that each Primary EDNS server separately collects metric information out of band and each Primary DNS server is an authoritative source for zone information. At the data center 126 disposed in Seattle, Wash. (seattle/domain.com), Primary EDNS and Primary DNS servers 152 are included in the same system. Also, Primary EDNS and Primary DNS servers 154 are included in the data center 138 located in New York, N.Y. (newyork/domain.com). Both of these Primary DNS servers are authoritative sources for zone information that is used to resolve the client's domain name request. Each Primary EDNS system uses its separately collected metric information to perform the selected load balancing method and determine (resolve) an ip address for the client to optimally access resources associated with the requested domain name. Additionally, only one Host machine 120 is shown disposed at the data center 118 located in Tokyo, Japan (tokyo/domain.com).

FIG. 3B illustrates an overview 150B of another embodiment of a WAN architecture that is somewhat similar to the network architecture shown in FIG. 3A except that it includes Secondary DNS and Secondary EDNS servers in a data center that is geographically separate from another data center that includes Primary DNS and Primary EDNS servers. The transaction process is similar to the steps discussed above for FIG. 3A except that only the Primary EDNS server is collecting the metric information out of band from the SACs and other Host machines.

At the data center 126 disposed in Seattle, Wash. (seattle/domain.com), Secondary EDNS and Secondary DNS servers 156 are included in the same system. The Secondary EDNS server receives a copy of the metric information from the Primary EDNS server at specified intervals so that the Secondary EDNS server can use the selected balancing method to determine (resolve) an ip address for the optimal virtual server and provide access to resources associated with the client's domain name request. Additionally, the Secondary EDNS server receives zone information from the Primary DNS server at the data center 138 located in New York, N.Y.

FIG. 3C illustrates an overview 150C of another embodiment of a WAN architecture that is somewhat similar to the network architecture shown in FIG. 3B except that it includes a Secondary DNS server and a Primary EDNS server in the Seattle data center 126 which is geographically separate from the New York data center 138 which includes a Primary DNS server and a Primary EDNS server. The transaction process is similar to the steps discussed above for FIG. 3B except that the Primary EDNS server in the Seattle data center 126 collects metric information separately from the collection of metric information by the Primary EDNS server in the New York data center 138. The Primary EDNS server in the Seattle data center 126 uses its separately collected metric information to perform the selected balancing method and determine (resolve) an ip address for the optimal virtual server. Additionally, the Primary DNS server in the New York data center 138 provides the zone information to the Primary EDNS server in the Seattle data center 126.

FIG. 3D illustrates an overview 150D of another embodiment of a WAN architecture that is somewhat similar to the network architecture shown in FIG. 3A except that it includes a Secondary EDNS server and a Primary DNS server in the Seattle data center 126 which is geographically separate from the New York data center 138 which includes a Primary DNS server and a Primary EDNS server. The transaction process is similar to the steps discussed above for FIG. 3A except that only the Primary EDNS server in the New York data center 138 is collecting metric information which is copied to the Secondary EDNS server in the Seattle data center 126. Also, the Primary DNS servers in the Seattle data center 126 and the New York data center 138 are authoritative sources for zone information that is used to resolve the client's domain name request. The Primary and the Secondary DNS servers for a zone can give authoritative answers. However, the Primary DNS server maintains the zone files and the Secondary DNS server stores a copy of the zone files.

FIG. 3E illustrates an overview 150E of another embodiment of a WAN architecture that is somewhat similar to the network architecture shown in FIG. 3D except that the EDNSA programs are no longer included with the SACs. Instead, one of the EDNSA programs is included with a Secondary EDNS server and a Primary DNS server in a system 161 that is located in the Seattle data center 126. Also, the New York data center 138 includes a stand alone EDNSA program 141 and the Tokyo data center 118 includes another stand alone EDNSA program 121.

The transaction process for this embodiment is similar to the steps discussed above for FIG. 3D except that the EDNSA programs do not run on the SACs. In this embodiment, since the EDNSA program is employed in a stand alone system or implemented with a EDNS server, the processing load on the SAC is reduced. Also, the stand alone EDNSA program 121 (parent) located in the Tokyo data center 118 can locally obtain metric information from the Host machine 120 (non-BIG/ip) with a Simple Network Management Protocol reader (SNMP child factory). This information can be collected by the Primary EDNS server at specific intervals.

In FIGS. 1 through 3E, each embodiment shows the Internet 102 used to connect the local DNS 110 with other resources/servers on a publicly administered WAN. It is envisioned that the present invention may also be used with an intranet and a privately administered WAN.

Resolving an ip Address for a Domain Name

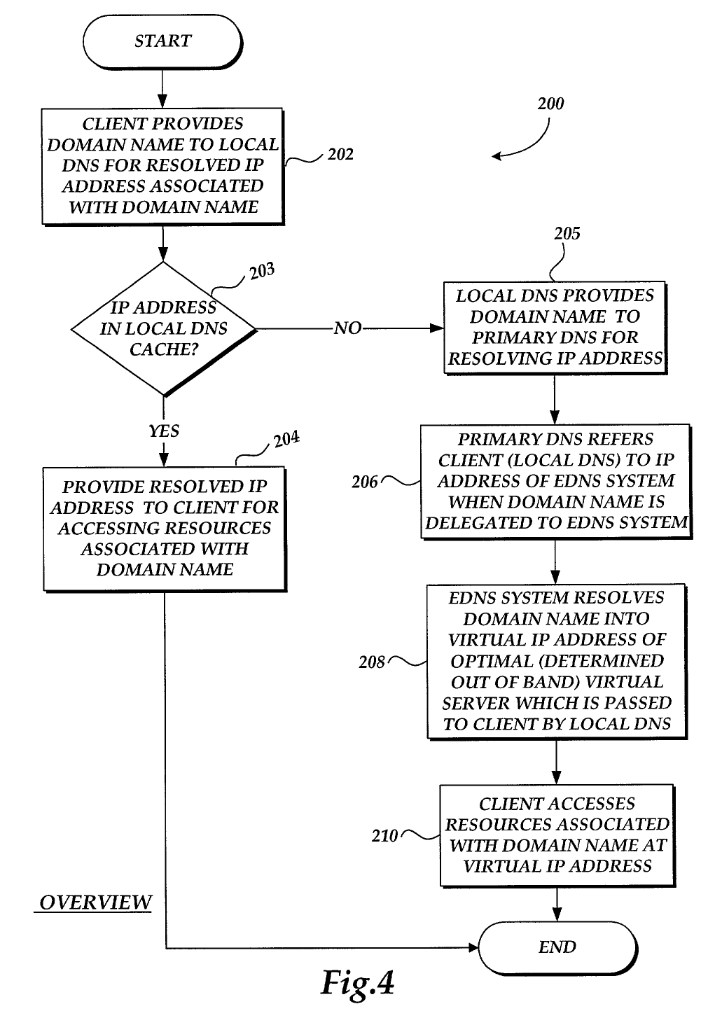

FIG. 4 illustrates a general overview 200 of the main logic flow of the present invention. Moving from a start block, the logic flows to a block 202 where the client communicates a domain name request to a local DNS server in the data center of a local ISP. The client may communicate with the local ISP through any one of several different devices, including a cable modem, a wireless modem, a telephone modem and a network interface card (NIC) on an intranet that is in communication with the local ISP. In response to the domain name request, the local DNS tries to provide the client with a resolved ip address from a local cache of resolved ip addresses.

Stepping to a decision block 203, when the resolved ip address for the requested ip address is in the local cache of the local DNS server, the logic will advance to a block 204 and this address will be provided to the client. The client will use the provided ip address to access resources associated with the domain name. Next, the logic moves to the end block and terminates.

However, if the determination at the decision block 203 is false, the logic flows to a block 205 and the local DNS server provides the requested domain name to the Primary DNS server for resolving into an ip address. At a block 206, when the domain name is delegated to a EDNS server, the Primary DNS server will refer the local DNS server to the EDNS's ip address. At a block 208, the EDNS system resolves the requested domain name into a virtual IP address for a determined virtual server and passes this ip address through the local DNS server to the client. The EDNS server employs at least one load balancing method to determine the optimal virtual server to provide the client with access to resources associated with the domain name. Metric information used for the load balancing determination is collected by the EDNS server at specified intervals out of band, i.e., a separate process is started to provide the metric information at regular intervals.

Flowing to a block 210, the client connects to the optimally determined virtual server at the virtual ip address and accesses resources associated with the requested domain name. Next, the logic steps to the end block and the main logic flow terminates.

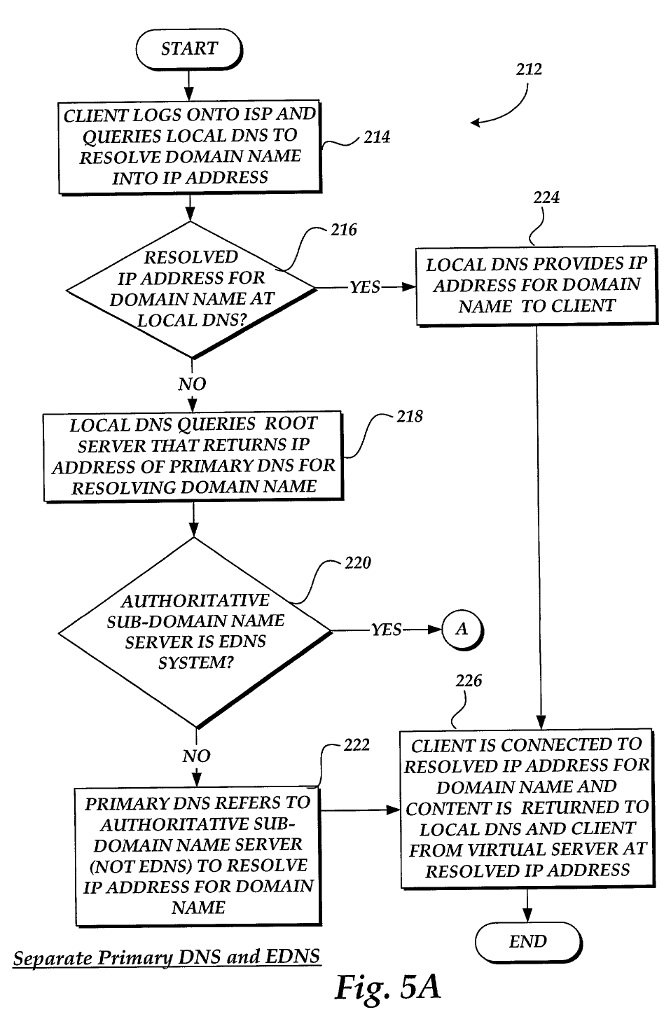

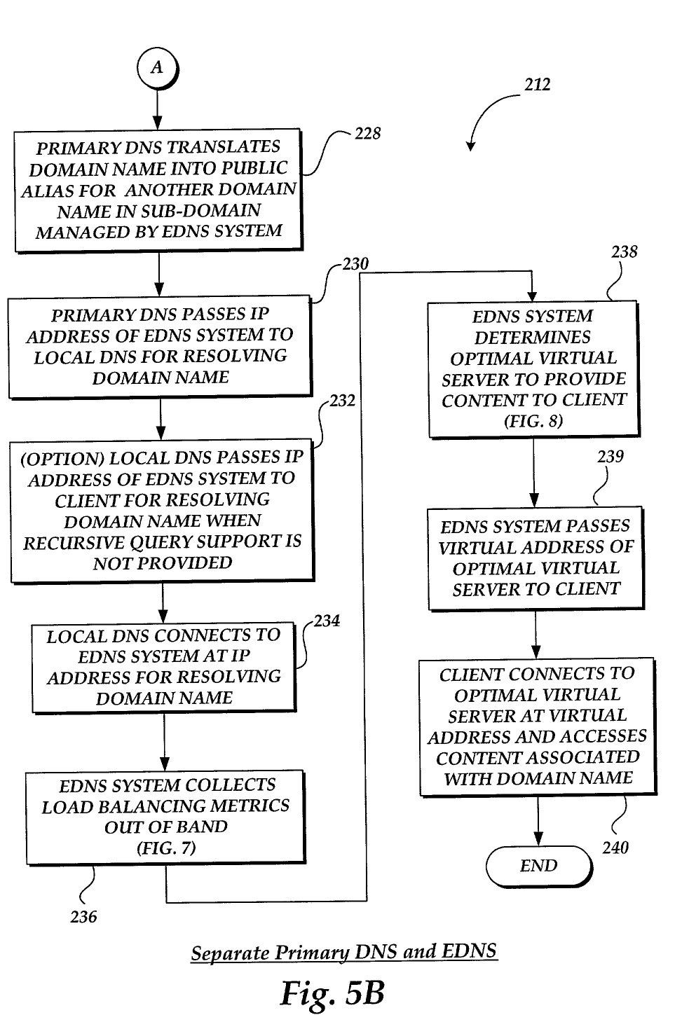

In FIGS. 5A and 5B, an overview 212 is shown of the logic flow for a WAN architecture when a EDNS system is added to an existing network that includes a separate Primary DNS server. Moving from a start block, the logic steps to a block 214 where the client logs onto (connects to) an ISP and queries a local DNS server to provide a resolved ip address for a domain name request. At a decision block 216, the logic determines if the resolved ip address is located in a cache for the local DNS server. If so, the logic moves to a block 224 where the local DNS server provides the cached ip address that is associated (resolved) with the domain name to the client. Flowing to a block 226, the client is connected to the resolved ip address so that the client may access resources (content) associated with the domain name. Next, the logic moves to an end block and the logic is terminated.

However, at the decision block 216, if the resolved ip address is not located in a cache for the local DNS server, the logic advances to a block 218. The local DNS server queries a root server which returns the ip address of a Primary DNS that is the authoritative source for zone information related to the requested domain name. Moving to a decision block 220, the local DNS server connects to the returned ip address for the Primary DNS server. Also, if the Primary DNS server determines that the authoritative sub-domain server for the requested domain name is not a EDNS system, the logic will step to the block 222. The non-EDNS authoritative sub-domain server will resolve the requested domain name into an ip address that is provided to the client. The logic will advance to the block 226 where substantially the same logic discussed above is performed, i.e., the client will connect to the resolved ip address and access resources associated with the domain name. Next, the logic advances to the end block and terminates.

Alternatively, at the decision block 220, if the Primary DNS server determines that the authoritative sub-domain server is a EDNS system, the logic will move to a block 228 as shown in FIG. 5B. The Primary DNS server will translate the domain name into a public alias for another domain name in the sub-domain managed by the EDNS system.

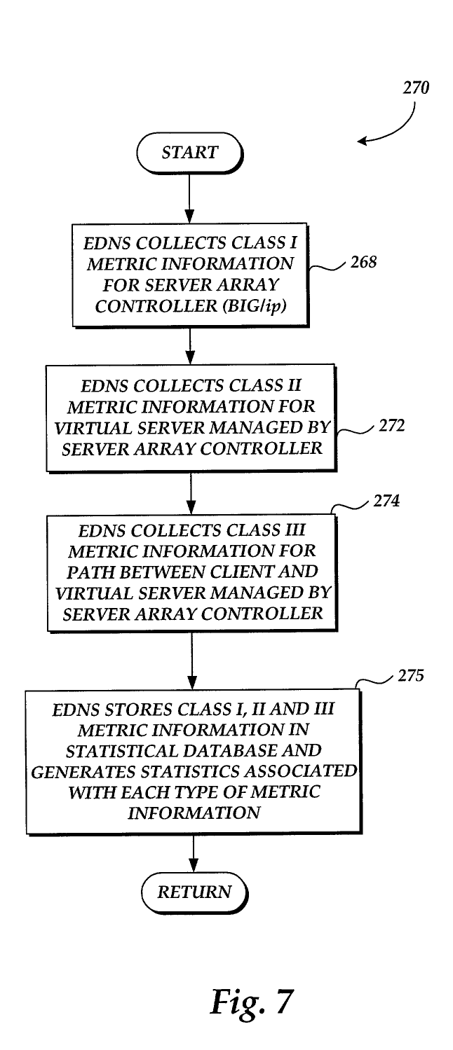

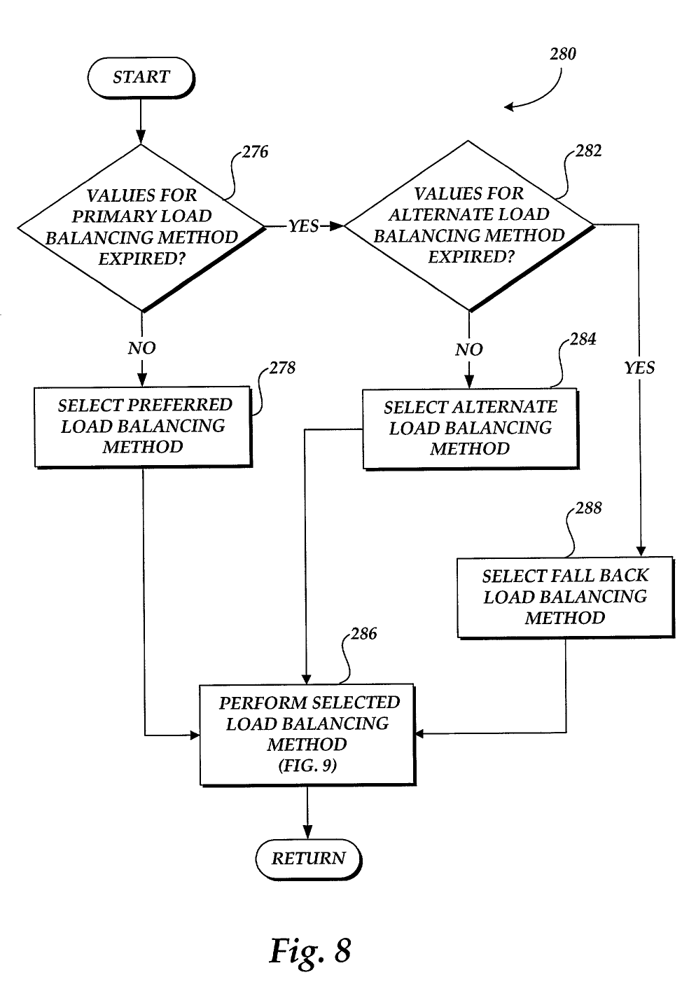

The logic flows to a block 230 where the primary DNS server passes the ip address of the EDNS system to the local DNS. Optionally, when a recursive query is not supported by the local DNS server, the logic may step to a block 232 where the local DNS may provide the ip address of the EDNS system to the client for resolving the ip address associated with the domain name. Advancing to a block 234 the local DNS server connects to the EDNS system and requests a resolved ip address for the requested domain name. At a block 236, the EDNS system will collect load balancing metrics out of band as shown in FIG. 7 discussed below. The logic steps to a block 238 where the EDNS system determines the optimal virtual server to provide content to the client as illustrated in FIG. 8 discussed in greater detail below. At a block 239, the EDNS system returns the virtual ip address of the optimal virtual server to the client. The logic flows to a block 240 where the client connects to the optimal virtual server at the virtual ip address and accesses resources associated with the domain name. Next, the logic steps to an end block and the logic terminates.

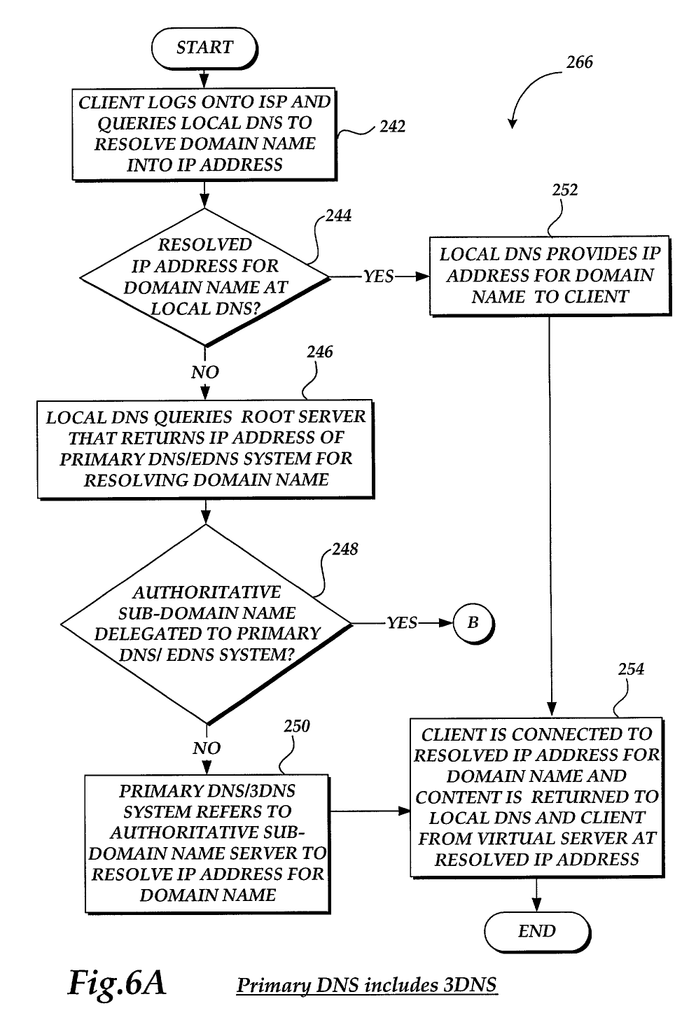

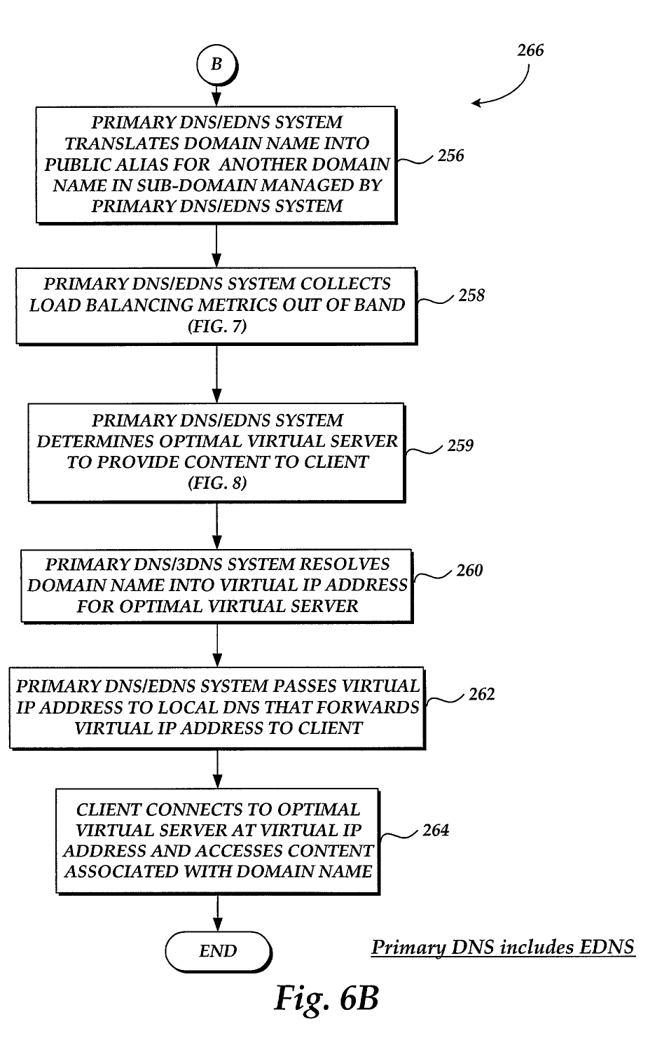

Turning to FIGS. 6A and 6B, an overview 266 is illustrated of the logic flow for processing a domain name request in a WAN architecture that includes a Primary DNS server and a EDNS server in the same system at a data center. Moving from a start block, the logic flows to a block 242 where the client logs onto (connects to) an ISP and queries a local DNS server to provide a resolved ip address for a domain name request. At a decision block 244, the logic determines if the resolved ip address is located in a cache for the local DNS server. If so, the logic moves to a block 252 where the local DNS server provides the cached ip address that is associated (resolved) with the domain name to the client. Flowing to a block 254, the client is connected to the resolved ip address so that the client may access resources (content) associated with the domain name. Next, the logic moves to an end block and the logic is terminated.

Alternatively, at the decision block 244, if the resolved ip address is not located in a cache for the local DNS server, the logic advances to a block 246. The local DNS server queries a root server which returns the ip address of a Primary DNS/EDNS system that is the authoritative source for zone information related to the requested domain name. Moving to a decision block 248, the local DNS server connects to the returned ip address for the Primary DNS/EDNS system. Also, if the Primary DNS/EDNS system determines that the authoritative sub-domain is not delegated to the system, the logic will step to a block 250. The Primary DNS/EDNS system will refer the local DNS to the ip address of the actual authoritative sub-domain server delegated to resolve the requested domain name into a different ip address which is provided to the client. The logic advances to the block 254 where substantially the same logic discussed above is performed, i.e., the client will connect to the resolved ip address and access resources associated with the domain name. Next, the logic advances to the end block and terminates.

However, at the decision block 248, if the Primary DNS/EDNS system determines that the authoritative sub-domain server is the system, the logic will move to a block 256 as shown in FIG. 6B. The Primary DNS/EDNS system will translate the domain name into a public alias for another domain name in the sub-domain delegated to the Primary DNS/EDNS system. However, if the Primary DNS/EDNS system includes a Primary DNS server in the same computer as the Primary EDNS server, this delegation is not required or done.

The logic flows to a block 258 where the Primary DNS/EDNS system collects load balancing metrics out of band as shown in FIG. 7 discussed below. The logic steps to a block 259 where the Primary DNS/EDNS system determines the optimal virtual server to provide content to the client as illustrated in FIG. 8, which is discussed in greater detail below. At a block 260, the Primary DNS/EDNS system resolves the domain name into a virtual ip address for the optimal virtual server to provide access to resources associated with the domain name. The logic flows to a block 262 where the virtual ip address is returned to the local DNS server and the client. At a block 264, the client connects to the optimal virtual server at the virtual ip address and accesses the resources associated with the domain name. Next, the logic steps to an end block and the logic terminates.

Metric Information Collection

In FIG. 7, an overview 270 is presented of the logic flow performed by a Primary EDNS server to collect metric information out of band with a EDNSA program. Advancing from a start block, the logic moves to a block 268 where the Primary EDNS server collects Class I metric information associated with each SAC. The Class I metric information includes packet rate, CPU utilization and up versus down status of the controller. The SAC is down when the maximum predefined number of connections to the SAC is exceeded. Once, the controller is “down” the Primary EDNS server will wait for a user-defined number of seconds before trying to refresh the up/down status of the controller. Additionally, an “alive” time stamp is provided each time the Primary EDNS server receives any communication from a EDNSA program that monitors the SAC. Also, a “data” time stamp is provided each time the Primary EDNS server receives an iQuery protocol packet containing Class I metric information from the EDNSA program that is monitoring the SAC.

Flowing to a block 272, the Primary EDNS server collects out of band from a EDNSA program the Class II metric information associated with each virtual server managed by the SAC. The Class II metric information includes the current number of connections per virtual server, average packet rate of all nodes assigned to each virtual server, number of nodes alive per virtual server and the up versus down status of each virtual server. The up/down status of a virtual server is determined by considering several factors, including: (1) is the SAC or Host machine that governs the virtual server available; (2) is the virtual server enabled; (3) is the number of available connections for the virtual server exceeding the virtual server's connection count limit; (4) is the number of nodes servicing the virtual server greater than zero; and (5) does the metric information have a fresh time stamp, i.e., not expired? Also, for all of the load balancing methods, the EDNS system will only select a virtual server that is identified as “up.” Additionally, an “alive” time stamp is included when all of the Class II metric information is provided to the Primary EDNS server by the EDNSA program.

Moving to a block 274, the Primary EDNS server collects out of band from a EDNSA program the Class III metric information associated with a path for a packet that is sent between the client and the virtual server. The Class III metric information includes round trip time (RTT or latency), packet loss and hops. RTT and packet loss are collected together and the hops metric information is separately collected. Each item of Class III metric information includes a separate “alive” time stamp. The logic advances to a block 275 where the Primary EDNS system stores Class I, II and III metric information values in a statistical database and generates statistics associated with each metric information class. The EDNS system sorts requests for path metric information and prioritizes them based on the statistics. In this way, the EDNS system can dynamically adjust the number of requests for path metric information based on the actual number of requests answered and the statistics associated with a path. Next, the logic moves to a return block and jumps back to the main logic flow.

Additionally, in another embodiment, both Primary and Secondary EDNS systems may send an iQuery message request and receive the metric information broadcasted by the EDNSA program. This embodiment enables a redundant backup of the most current metric information on each EDNS system and information updates can be performed at the same time for both the Primary and Secondary EDNS systems.

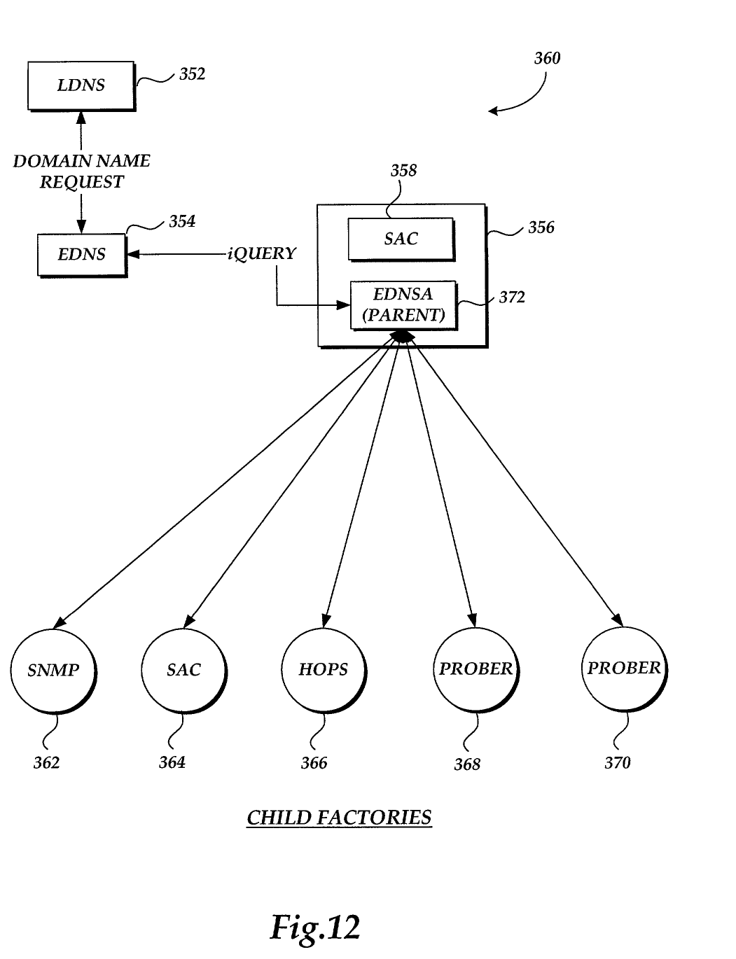

FIG. 12 provides an overview 360 illustrating the transaction process for an out of band collection of metric information that is transferred to a EDNS system by a EDNSA program. The local DNS server 352 communicates a domain name request to the EDNS system 354 that is the authoritative source for information related to the sub-domain name. Out of band of the domain resolution process, the EDNS system communicates an iQuery protocol request to a EDNSA program 372 disposed at a data center 356 which is in communication with a SAC 358. In this example, the EDNSA program 372 is a parent application that has spawned several child factories to collect various types of metric information. These child factories include: (1) an SNMP reader 362 for collecting Class I and II metric information from a Host machine and other types of server array controllers; (2) a SAC reader for collecting Class I and Class II metric information from the SAC 358; (3) a hops reader for collecting Class III metric information related to hops; and (4) a prober for collecting Class III packet loss and RTT metric information. The EDNSA program 372 provides the collected metric information to the EDNS system 354 by an iQuery protocol request at defined intervals. Although not shown here, the EDNS system 354 may employ the iQuery protocol to request collected metric information from several EDNSA programs that are separately disposed at geographically distributed data centers.

Additionally, in another embodiment, the Secondary or Primary EDNS may run the EDNSA program for collecting the metric information. Also, the EDNSA program may be disposed with a Host machine for collecting metric information related to RTT, completion rate and the number of hops between routers for a transaction between a virtual server and the local DNS.

Statistics

The Primary EDNS system generates statistics related to each SAC, Host, virtual server, path, local DNS and Wide ip. For example, the SAC statistics include: (1) the up versus down availability of the SAC; (2) the number of iQuery packets between a EDNS system and a SAC; (3) the total number of packets in and out of the SAC; (4) the number of packets sent per second; (5) the number of virtual servers managed by the SAC; (6) the number of times data is refreshed using the iQuery protocol; and (7) the amount of time the SAC is active.

For a Host machine, the statistics include: (1) the number of virtual servers managed by the Host machine; (2) the number of times a particular Host machine was chosen by a Wide ip for load balancing; and (3) the number of times data is refreshed. The virtual server statistics include: (1) the number of times a particular virtual machine was chosen by a Wide ip for load balancing; (2) the number of times data is refreshed; (3) the number of connections that are handled by the virtual server; and (4) the up versus down availability of the virtual server.

The path statistics include: (1) the average RTT for transactions between the SAC and a local DNS; (2) the packet completion rate (packet loss); (3) the number of times a specified path is chosen; (4) the number of times that the EDNS system has received data about the specified path; and (5) the number of hops between routers for a transaction between a virtual server and the local DNS. The Local DNS statistics include a measure of how often a particular Local DNS is used and the number of times that the EDNS system received a resolution request from this Local DNS.

The Wide ip statistics include: (1) the weighting values for the virtual servers managed by a particular SAC; (2) the weighting values for the virtual servers managed by other Host machines; (3) the number of successful name resolutions; (4) the number of unsuccessful name resolutions; (5) the load balancing modes used for the pool of virtual servers managed by each SAC; (6) the load balancing modes used for the pool of virtual servers managed by each Host machine; (7) the number of virtual servers managed by each SAC which are used to load balance the specified Wide ip; and (8) the number of virtual servers managed by each Host machine which are used to load balance the specified Wide ip.

Load Balancing Methods

FIG. 8 provides an overview 280 of the logic used to select a predefined load balancing method. Advancing from a start block, the logic steps to a decision block 276 where it is determined if the time stamp is expired for metric information associated with the preferred load balancing method. If no, the logic flows to a block 278 and the preferred load balancing method is selected for determining the optimal virtual server to provide access to resources associated with a requested domain name. The logic moves to a block 286 where the selected (preferred) load balancing method is performed. The performance of the selected load balancing method is shown in FIGS. 8, 9, 10A and 10B which is discussed below. Next, the logic steps to a return block and returns to the main logic flow of the transaction process.

However, if the determination at the decision block 276 is true, i.e., the time stamp is expired, the logic will advance to a decision block 282 where it is determined if a time stamp for the values for the alternate load balancing method is expired. If negative, the logic steps to a block 284 where the alternate load balancing method is selected to determine the optimal virtual server to provide access to resources associated with a requested domain name. Moving to the block 286, the selected (alternate) load balancing method is performed and the logic advances to the return block where it jumps back to the main logic flow of the transaction process.

Alternatively, if the determination at the decision block 282 is true, i.e., the time stamp expired for the values for the alternate load balancing method, then the logic will flow to a block 288 where a fall back load balancing method is selected to determine the optimal virtual server to provide access to resources associated with a requested domain name. Stepping to the block 286, the selected (fall back) load balancing method is performed and the logic advances to the return block where it returns to the main logic flow of the transaction process.

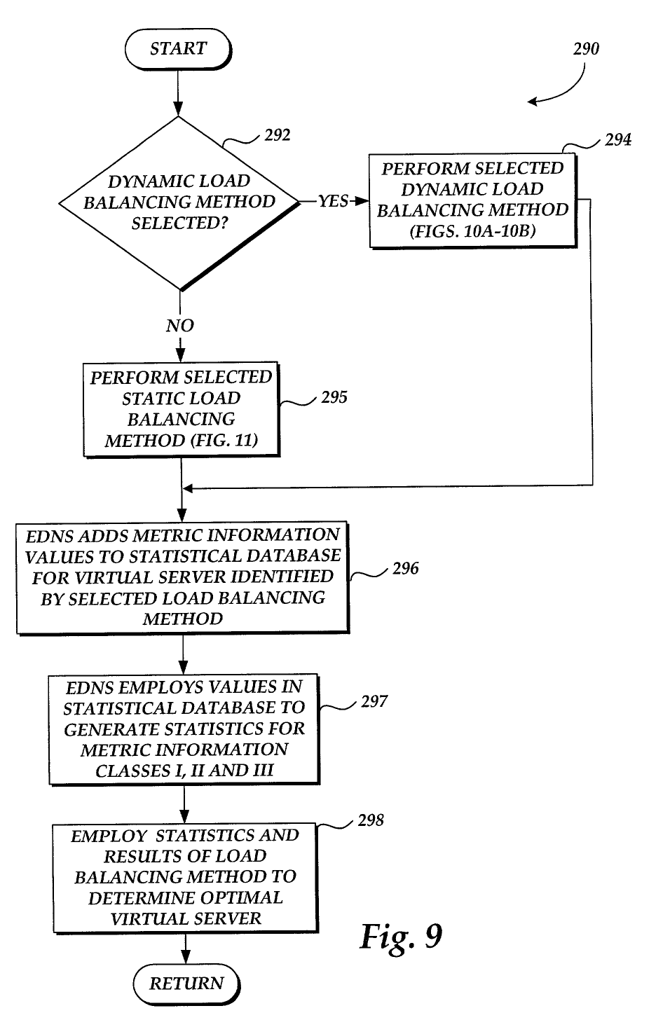

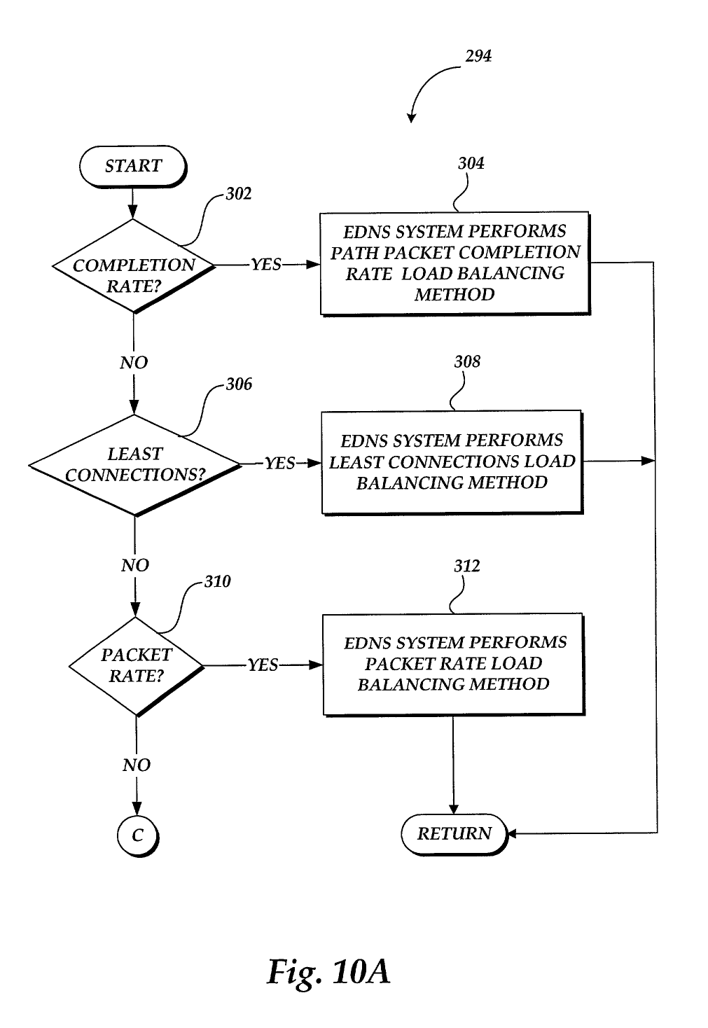

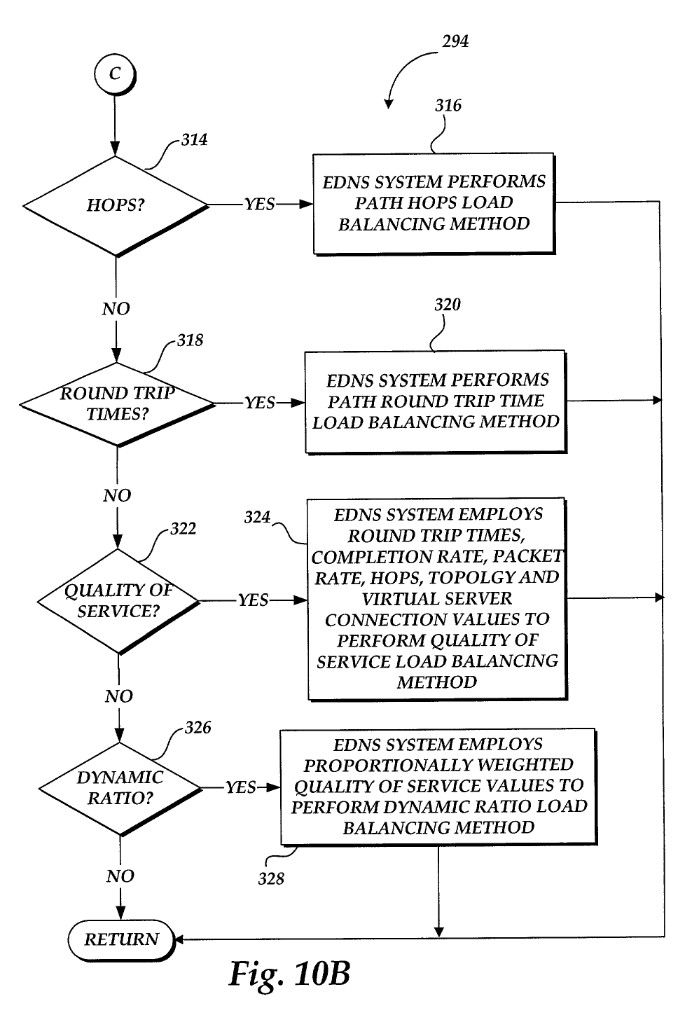

In FIG. 9, an overview 290 is shown of the logic for performing the selected load balancing method. Flowing from a start block, the logic moves to a decision block 292 where it is determined if a dynamic load balancing method is selected. If so, the logic steps to a block 294 and the selected dynamic load balancing method is performed. As discussed below, FIGS. 10A and 10B show in greater detail the performance of the selected dynamic load balancing method. The logic advances to a block 296 where the EDNS system will add the collected metric information values for the virtual server identified by the selected load balancing method to a statistical database. The logic steps to a block 297 where the EDNS system employs the values stored in the statistical database to generate statistics for all classes of metric information. The logic flows to a block 298 where the generated statistics may be displayed to the user. Also, these statistics and the results of the selected load balancing method are employed to choose an optimal virtual server to provide the client with access to resources associated with the domain name request. Next, the logic steps to a return block and returns to the main logic flow.

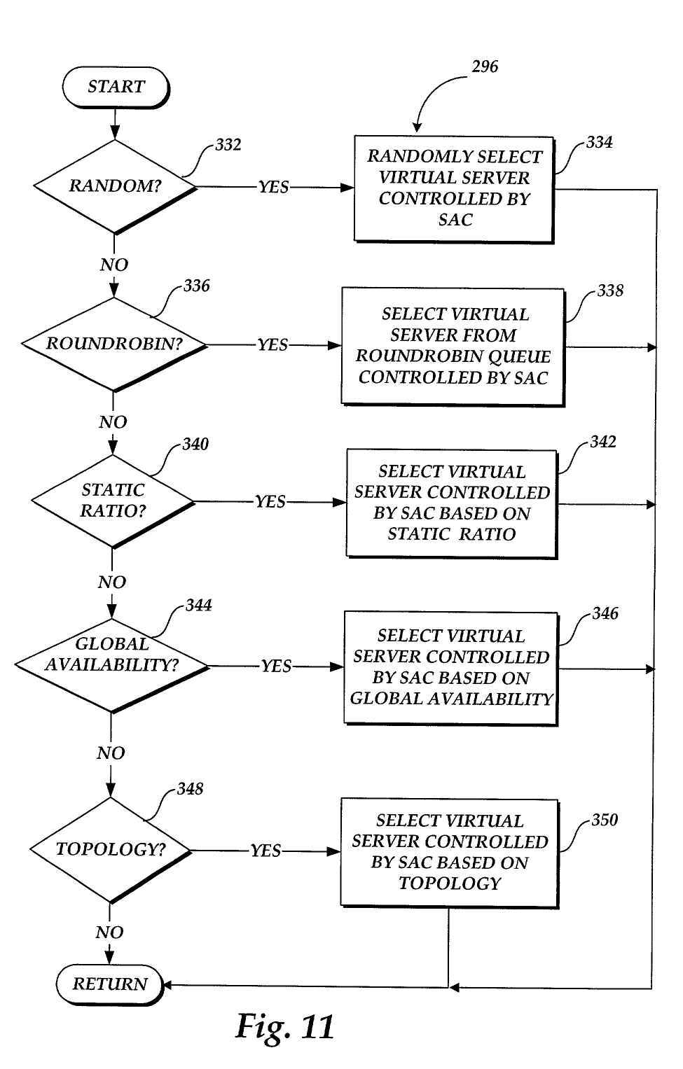

Alternatively, if a dynamic load balancing mode is not selected, the logic moves from the decision block 292 and flows to the block 295 where the selected static load balancing method is performed. As discussed below, FIG. 11 shows in greater detail the performance of the selected static load balancing method. Next, the logic advances through blocks 296, 297 and 298 where substantially the same steps as described above are performed to select a virtual server to provide the client with access to resources associated with the domain name request. Next, the logic advances to a return block and jumps back to the main logic of the transaction process.

FIGS. 10A and 10B illustrate the logic used to perform a selected dynamic load balancing method as shown in the block 294 in FIG. 9. Moving from a start block to a decision block 302, a determination is made if the path packet completion rate load balancing method is selected. If true, the logic moves to a block 304 and the EDNS system employs the path packet completion rate values to perform the selected method which determines a virtual server on a SAC that is dropping or timing out the least number of packets between the virtual server and the local DNS. The logic moves to a return block and returns to the logic flow at block 294 in FIG. 9.

Alternatively, if the determination at the decision block 302 is false, the logic advances to a decision block 306 where a determination is made whether the least connections load balancing method is selected. If true, the logic steps to a block 308 and the EDNS system employs the least connections values to perform the selected method which determines a virtual server on a SAC that is currently maintaining the least number of connections. Next, the logic moves to a return block and returns to the logic flow at block 294 in FIG. 9.

However, if the determination at the decision block 306 is false, the logic advances to a decision block 310 where a determination is made whether the packet rate values load balancing method is selected. If true, the logic steps to a block 312 and the EDNS system employs the packet rate values to perform the selected method which determines a virtual server on a SAC that is currently processing least number of packets per second. The logic moves to a return block and returns to the logic flow at block 294 in FIG. 9.

Also, if the determination at the decision block 310 is false, the logic advances to a decision block 314 illustrated in FIG. 10B where a determination is made whether the hops load balancing method is selected. If true, the logic steps to a block 316 and the EDNS system employs the hops values to perform the selected method which determines a virtual server on a SAC that uses the least number of hops between routers to reach the local DNS. Next, the logic moves to a return block and returns to the logic flow at block 294 in FIG. 9.

Additionally, if the determination at the decision block 314 is false, the logic advances to a decision block 318 where a determination is made whether the round trip times load balancing mode is selected. If true, the logic steps to a block 320 and the EDNS system employs the round trip times values to perform the selected method which determines a virtual server on a SAC that has the fastest measured round trip time from the SAC to the local DNS. Next, the logic moves to a return block and returns to the logic flow at block 294 in FIG. 9.

Alternatively, if the determination at the decision block 318 is false, the logic advances to a decision block 322 where a determination is made whether the Quality of Service (QOS) load balancing mode is selected. If true, the logic steps to a block 324 and the EDNS system employs a user configurable combination of all collected metric information to define a QOS metric value. This method determines a virtual server on a SAC that has the highest metric value. A user configurable QOS equation for determining the QOS metric value is as follows: QOS=A (1/packet rate)+B(1/round trip time)+C(1/hops)+D(virtual server capacity)+E(completion rate)+F(topology score). The user may edit the QOS variables A, B, C, D, E and F to weight the various portions of the collected metric information and define the QOS metric value. Each of these metric values could also be associated with a QOS variable to individually weight their effect on the QOS score. The virtual server capacity is determined by the available number of connections and the average packet rate of the nodes behind the SAC that serve the virtual server. Also, the topology score is set in a user configurable topology score statement 376 as illustrated in FIG. 14. Next, the logic moves to a return block and returns to the logic flow at block 294 in FIG. 9.

Further, if the determination at the decision block 322 is false, the logic advances to a decision block 326 where a determination is made whether the Dynamic Ratio load balancing mode is selected. If true, the logic steps to a block 328 and the EDNS system employs a user configurable combination of weights for the Quality of Service metric information to define a Dynamic Ratio metric value for each virtual server for a period of time. Repeated requests from a particular Local DNS are distributed to virtual servers so that the proportions defined by the Dynamic Ratio metric values are maintained. This method determines a virtual server on a SAC that has the highest Dynamic Ratio metric value. Three user configurable Dynamic Ratio equations for determining the Dynamic metric value (score) are as follows:

score_{—}dynamic=A(p/packet rate)+B(q/round trip time)+C(r/hops)+D(virtual server capacity/s)+E(completion rate/t)+F(topology score/u). Equation I.

min_{—}score_{—}dynamic=min(scoreε{score_{—}dynamic∀virtual servers in this pool}). Equation II.

ratio_{—}dynamic=rint(log(scored_{—}dynamic)+[1−log(min_{—}score_{—}dynamic)]). Equation III.

ratio_{—}dynamic=RANGE(ratio_{—}dynamic, 1, 10). Equation IV:

The user may edit the QOS variables p, q, r, s, t and u to weight the various portions of the collected metric information and define the Dynamic Ratio metric value (score). Next, the logic moves to a return block and returns to the logic flow at block 294 in FIG. 9.

FIG. 11 illustrates the logic used to perform a selected static load balancing method as shown in the block 296 in FIG. 9. Moving from a start block to a decision block 332, a determination is made if the random load balancing method is selected. If true, the logic moves to a block 334 and the EDNS system performs the selected method by randomly selecting a virtual server on a SAC. The logic moves to a return block and returns to the logic flow at block 296 in FIG. 9.

Alternatively, if the determination at the decision block 332 is false, the logic advances to a decision block 336 where a determination is made whether the round robin load balancing method is selected. If true, the logic steps to a block 338 and the EDNS system performs the selected method by selecting a virtual server from a round robin queue managed by a SAC. Next, the logic moves to a return block and returns to the logic flow at block 296 in FIG. 9.

Also, if the determination at the decision block 336 is false, the logic advances to a decision block 340 where a determination is made whether the static ratio load balancing method is selected. If true, the logic steps to a block 342 and the EDNS system performs the selected method by selecting a virtual server from a weighted round robin queue managed by a SAC. Each virtual server has a user configurable value that is weighted to determine the proportion of connections that will go to each virtual server over time. The higher the weighted value, the more connections to the virtual server. In this way, the user may weight the number of connections provided to each virtual server based on the particular capabilities of each server. Next, the logic moves to a return block and returns to the logic flow at block 296 in FIG. 9.

Further, if the determination at the decision block 340 is false, the logic advances to a decision block 344 where a determination is made whether the global availability load balancing method is selected. If true, the logic steps to a block 346 and the EDNS system performs the selected method by selecting an available virtual server from a user configurable global availability list that is prioritized. Each EDNS server on a network can have a differently configured global availability list. Next, the logic moves to a return block and returns to the logic flow at block 296 in FIG. 9.

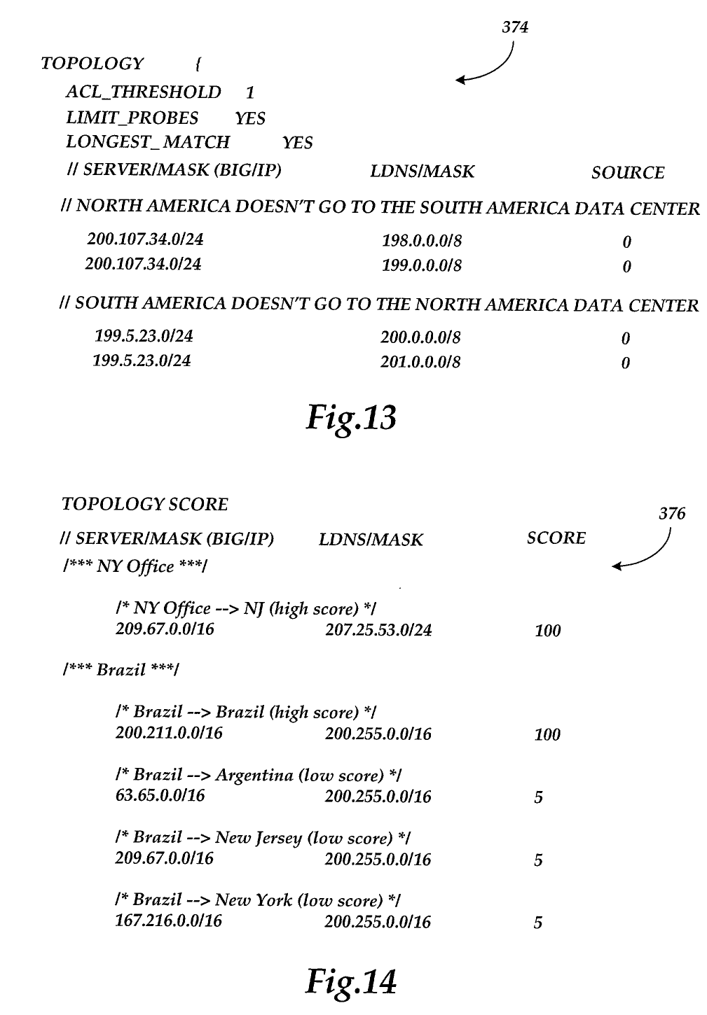

However, if the determination at the decision block 344 is false, the logic advances to a decision block 348 where a determination is made whether the topology load balancing method is selected. If true, the logic steps to a block 350 and the EDNS system performs the selected method by selecting an available virtual server from a user configurable topology statement 374 as illustrated in FIG. 13. Generally, each EDNS server on a network employs the same topology statement that causes domain name requests to be redirected to virtual servers that are within a particular geographic region. However, differently configured topology statements could also be used by each EDNS server. Next, the logic moves to a return block and returns to the logic flow at block 296 in FIG. 9.

Although not shown in the figures discussed above, it is envisioned that another embodiment of the present invention could position the EDNS system at the data center that includes the local DNS for reducing the amount of time to resolve an ip address for a virtual server that can provide access to resources associated with a domain name request. It is also envisioned that the EDNS system could be included with a cache server for the local DNS. The EDNS system at the same data center as the local DNS may be a primary or secondary EDNS and it may include a primary DNS or a secondary DNS. Additionally, the logic flow for a EDNS system positioned at the same data center as the local DNS is substantially similar to the transaction logic discussed above.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. Method for balancing the load on a plurality of servers that provide access to resources associated with a domain name, comprising:
(a) receiving a request for access to resources associated with the domain name;
(b) determining the load for each of a plurality of servers that provide access to resources associated with the domain name and selecting one of the plurality of servers to provide the access, the selection of the server being based on a determination for optimally balancing the load on the plurality of servers; and
(c) resolving an Internet protocol (ip) address of the selected server so that the accessing of resources associated with the domain name at the resolved ip address of the selected server will cause the load to be optimally balanced on the plurality of servers on a network.

2. The method of claim 1, further comprises querying a local Domain Name System (DNS) to provide the ip address associated with the domain name.

3. The method of claim 2, wherein when the ip address is not present at the local DNS, querying a primary DNS to resolve the ip address associated with the domain name.

4. The method of claim 3, wherein when the primary DNS determines the domain name is delegated to a EDNS, further comprising referring the local DNS to the EDNS to resolve the ip address for the selected server, the EDNS employs at least one of a plurality of load balancing determinations to select one of the plurality of servers and resolve the ip address for the selected server.

5. The method of claim 4, wherein the EDNS includes the primary DNS.

6. The method of claim 4, wherein the EDNS includes a secondary DNS.

7. The method of claim 4, wherein the EDNS is a primary EDNS, the primary EDNS collecting metric information employed by the selected load balancing determination to select the server to provide access to the resources associated with the domain name.

8. The method of claim 4, wherein selecting one of the plurality of servers that will optimally balance the load, further comprises choosing the server based on one of a plurality of static load balancing determinations for each server, the plurality of static load balancing determinations being selectable and including random, round robin, static ratio, global availability and topology.

9. The method of claim 4, wherein selecting one of the plurality of servers that will optimally balance the load, further comprises choosing the server based on one of a plurality of dynamic load balancing determinations for each server, the dynamic load balancing determinations being selectable and including completion rate, least connections, packet rate, hops, round trip times, quality of service and dynamic ratio.

10. The method of claim 4, further comprising selecting one of the plurality of load balancing determinations as a primary load balancing determination, the primary load balancing determination being used to select the server when a time stamp is not expired, the time stamp being associated with metric information used by the primary load balancing determination.

11. The method of claim 10, further comprising selecting one of the plurality of load balancing determinations as an alternate load balancing determination, the alternate load balancing determination being employed to select the server when the time stamp associated with the metric information used by the primary load balancing determination is expired, another time stamp being associated with metric information employed by the alternate load balancing determination.

12. The method of claim 11, further comprising selecting one of the plurality of load balancing determinations as a fallback load balancing determination, the fallback load balancing determination being employed to select the server when the time stamp associated with metric information used by the primary load balancing determination and the other time stamp associated with metric information employed by the alternate load balancing determination are expired.

13. The method of claim 7, further comprising a plurality of EDNSs that are separately disposed at a plurality of geographically distributed data centers, each data center including at least one of a server array controller, host machine and ENDS.

14. The method of 13, wherein at least one of the plurality of EDNSs is a secondary EDNS, the secondary EDNS storing a copy of the metric information collected by the primary EDNS, the secondary EDNS employing the copy of metric information to select a particular server at that will optimally balance the load for accessing resources.

15. The method of 13, wherein at least one of the plurality of EDNSs is a secondary EDNS, the secondary EDNS collecting metric information that is employed to select a particular server that will optimally balance the load for accessing resources

16. The method of claim 4, further comprising a server array controller for managing access to at least one of the plurality of servers, the server array controller being in communication with the EDNS.

17. The method of claim 16, wherein the server array controller is a BIG/IP server array controller.

18. The method of claim 1, wherein the selected server is a stand-alone server.

19. The method of claim 4, further comprising an agent program that collects the metric information and communicates the collected metric information to the EDNS when the EDNS is not resolving the ip address for the resources associated with the domain name request.

20. The method of claim 1, wherein the network comprises a wide area network, Internet and intranet.

21. The method of claim 4, further comprising a wide ip that maps the domain name to at least one server, the wide ip being employed when the primary DNS is separate from the EDNS.

22. The method of claim 21, wherein the wide ip maps the domain name to one of the plurality of load balancing determinations.

23. The method of claim 4, further comprising generating statistics from metric information collected by the EDNS and enabling statistics to be generated for a particular aspect of the network, including server array controller, host machine, server, path and wide ip configuration.

24. The method of claim 23, wherein the load balancing determination is at least partially based on the generated statistics.

25. The method of claim 23, wherein the statistics for the server array controller include the up versus down availability of the server array controller, number of packets between the EDNS and the server array controller, the total number of packets in and out of the server array controller, the number of packets processed by the kernel per second, the number of servers managed by the server array controller, the number of times data is refreshed, the amount of time the server array controller is active.

26. The method of claim 23, wherein the statistics for the host machine include the number of servers managed by the host machine, number of times a particular host machine was chosen by a wide ip for load balancing and the number of times data is refreshed.

27. The method of claim 23, wherein the statistics for the server include the number of times a particular machine was chosen by a wide ip for load balancing, the number of times data is refreshed, the number of connections that are handled by the server and the up versus down availability of the server.

28. The method of claim 23, wherein the statistics for the path include the average round trip time (RTT) for transactions between the server array controller and a local DNS, the packet completion rate between the server array controller and the local DNS, the number of times a specified path is chosen, the number of times that the EDNS has received data about the specified path and the number of hops between routers for a transaction between the local DNS and the selected server.

29. The method of claim 23, wherein the statistics for the local DNS include a measure of how often a particular local DNS is used and the number of times that the EDNS received a resolution request from the local DNS.

30. The method of claim 22, wherein the statistics for the wide ip include weighting values for the servers managed by a particular server array controller, weighting values for the servers managed by another Host machine, the number of successful domain name resolutions, the number of unsuccessful name resolutions, the load balancing modes used for the pool of servers managed by each server array controller, the load balancing modes used for the pool of servers managed by each Host machine, the number of servers managed by each server array controller that are used to load balance a specified wide ip, and the number of servers managed by each host machine that are used to load balance the specified wide ip.

31. The method of claim 4, wherein the EDNS employs an iQuery protocol to communicate the metric information from the agent program to the EDNS.

32. The method of claim 1, wherein the EDNS is a 3DNS server.

33. The method of claim 1, wherein at least a portion of the plurality of servers are virtual servers.

34. The method of claim 24, wherein the generated statistics include a quality of service value that is related to the sum of separate portions of collected metric information, including packet rate, round trip time, hops, virtual server capacity, completion rate and topology.

35. The method of claim 34, wherein each portion of the metric information is separately multiplied by a selectable value that determines the weight of that portion of the metric information in generating the quality of service value.

36. The method of claim 34, wherein the generated statistics include a dynamic ratio value for each virtual server managed by a server array controller, the dynamic ratio value being related to the quality of service value and having selectable values for determining the weight of each portion of the metric information that is employed to generate the dynamic ratio value.

37. A system for balancing the load on a plurality of virtual servers that provide access to resources associated with a domain name, comprising:
(a) a memory for storing logical instructions; and
(b) a processor for executing the logical instructions stored in the memory, the execution of the logical instructions causing functions to be performed, including:
(i) receiving a request for access to resources associated with the domain name;
(ii) determining the load for each of a plurality of virtual servers that provide access to resources associated with the domain name and selecting one of the plurality of virtual servers to provide the access, the selection of the virtual server being based on a determination for optimally balancing the load on the plurality of virtual servers; and
(iii) resolving an Internet protocol (ip) address of the selected virtual server so that the accessing of resources associated with the domain name at the resolved ip address of the selected virtual server by the client will optimally balance the load on all of the virtual servers on a network.

38. Method for balancing the load on a plurality of virtual servers that provide access to resources associated with a domain name, comprising:
(a) receiving a request from a client for access to resources associated with the domain name;
(b) querying a local Domain Name System (DNS) to provide the Internet protocol (ip) address associated with the domain name;
(c) when the ip address is not present at the local DNS, querying a primary DNS to resolve the ip address associated with the domain name;
(d) when the primary DNS determines the domain name is delegated to a EDNS system, referring the local DNS to the EDNS system to resolve the ip address associated with the domain name; and
(e) employing the EDNS system to balance the load on a plurality of virtual servers that provide access to resources associated with the domain name by selecting one of the plurality of virtual servers that optimally balances the load, the EDNS system resolving the ip address of the selected virtual server for the domain name and providing the ip address to the client, so that the client will access resources associated with the domain name at the resolved ip address of the selected virtual server.

39. A computer readable medium having computer executable instructions for performing the method recited in claims 1, 4, 19 or 23.
